(19) United States
(12) Patent Application Publication
(10) Pub. No.: US 2008/0157488 A1
(43) Pub. Date: Jul. 3, 2008

(54) Surgical coupling device

(76) Inventors: Michael Kullmer, Lemgo (DE); Martin Teller, Lemgo (DE)

Correspondence Address: BLISS MCGLYNN, P.C., 2075 WEST BIG BEAVER ROAD, SUITE 600, TROY, MI, 48084, US

(21) Appl. No.: 12/004,618

(22) Filed: Dec. 24, 2007

(30) Foreign Application Priority Data
Dec. 27, 2006 (DE) 10 2006 062 421.1

(51) Int. Cl. B23B 5/22

(52) U.S. Cl. 279/76

(57) ABSTRACT

A surgical coupling device for releasably connecting a handpiece to a surgical instrument, the handpiece being provided with a recess into which a coupling portion of the instrument can be detachably slid, an interior wall of the recess having formed thereon a locking recess with which a snap-in element can be brought into detachable engagement, the snap-in element being supported on the instrument, wherein the snap-in element is formed on a latch element which extends substantially in axial direction and which is radially shiftably supported on the instrument and which is biased by at least one elastic element radially outwards into an inoperative position, the latch element being movable by an actuating element against the bias of the elastic element into a release position.

### BACKGROUND OF THE INVENTION

1. Field of the Invention

The present invention relates to a surgical coupling device for detachably connecting a handpiece to a surgical instrument.

2. Description of the Related Art

Surgical instruments, which are inserted into a handpiece, are known in very different configurations. The handpieces are usually connected to a drive such that tools or portions of the surgical instruments can be driven, e.g. can be put into rotation. Such surgical instruments may, for example, be dental drills or cutters or they may also be formed as shaver instruments for arthroscopy.

It is also known (see e.g. EP 1 006 898 B1) that the handpiece is provided with a centric bore or recess into which a coupling portion or attachment portion of the surgical instrument is inserted. In this process corresponding drive couplings of the handpiece engage with coupling parts of the surgical instrument such that a rotary drive is realized. The insertion and locking of the surgical instrument in the handpiece is achieved in that the handpiece is provided with a locking recess with which a snap-in element of the surgical instrument can be detachably engaged. The locking recess may, for example, be formed as an annular groove or only be provided as a singular member. The snap-in element of the surgical instrument may, for example, be formed as a snap-in hook, a latch, or the like. When inserting the surgical instrument into the handpiece, a locking or coupling operation may thereby take place, which prevents an unintended detachment of the surgical instrument from the handpiece. In order to remove the surgical instrument from the handpiece, an actuator is, for instance, operated.

The known devices are often structured intricately and their manufacture is correspondingly cost-intensive and elaborate, and the devices are often poorly operable under surgical operating conditions.

### SUMMARY OF THE INVENTION

It is an object of the present invention to provide a surgical coupling device, which can be operated safely and easily while being of simple construction and manufactured in a simple and cost-effective way.

According to the present invention, the object is solved by the feature combination of the main claim; the sub-claims show further advantageous developments of the invention.

According to the present invention, the snap-in element is secured to a radially displaceable latch element. The latter is shifted between an inoperative position and a release position, the latch element being biased by means of an elastic element into the locking inoperative position. The operator can thus release the latch element in a very simple way by exerting pressure on the actuating element, so that the surgical instrument can be detached from the handpiece and removed.

The simple structure of the construction, according to the present invention, thereby ensures that even under very difficult surgical conditions an easy detachment is guaranteed. This can particularly be done in a simple way when the operator (surgeon, physician) wears surgical gloves or pays little attention to the unlocking process because of the space and time conditions.

Thanks to the elastic bias of the latch element it is possible to slide the surgical instrument directly into the handpiece, whereby locking is performed automatically. Hence, the operator need not carry out any further manipulations or operations. A successful snap-in operation can be recognized by way of the position of the actuating element, so that a visual check is also possible in an easy and reliable way.

The advantage of the configuration according to the present invention is also that the latch element is movable in a very simple way. This permits a simple and inexpensive basic structure that results in low manufacturing costs and shows a particularly reliable action. Likewise, assembly can also be accomplished according to the present invention in a very simple and inexpensive way. Since the surgical instrument is a wear part that must often be exchanged, these aspects play a particularly important role.

It is particularly advantageous when the latch element is substantially plate-shaped. This ensures easy operability that can inter alia be guaranteed by large-area power transmission and guidance without any jamming.

The latch element is preferably arranged in a groove of the surgical instrument and can thereby be guided in radial direction in a safe way.

In a particularly advantageous embodiment of the present invention, the actuating element comprises a manually operable pushbutton which may thus be given an adequately large size and dimensioned with an ergonomic design to ensure safe handling also under surgical conditions. The pushbutton is preferably connected to a pressure plate which rests radially outside against the latch element. This ensures high power transmission from the actuating element (pushbutton) to the latch element.

The elastic element is preferably designed in the form of a leaf spring which can be produced at low costs and ensures uniform bias without any jamming. Another advantage of this construction is that the leaf spring does not require any additional receiving or guiding elements but can be arranged in a simple way radially underneath the unlocking plate. It is possible by giving the leaf spring suitable dimensions to predetermine the unlocking force or release force in an appropriate way.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an axial partial sectional view of a surgical coupling device, according to the present invention.

FIG. 2 is an exploded view of the components of the surgical coupling device, according to the present invention.

### DESCRIPTION OF THE PREFERRED EMBODIMENT(S)

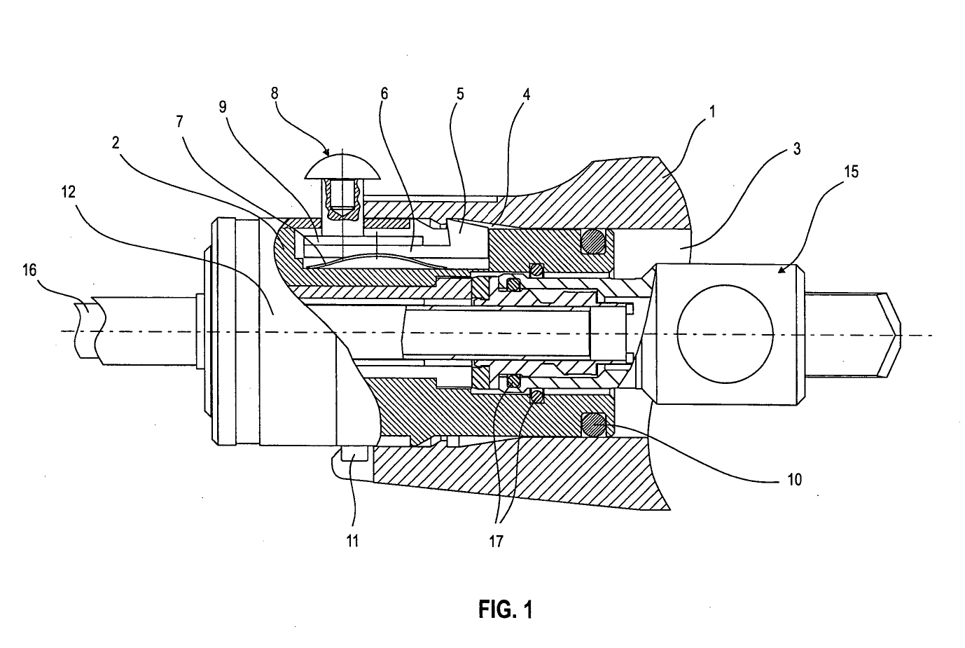

Referring now to the drawings, one embodiment of a surgical coupling device, according to the present invention, is shown. FIG. 1 is an axial sectional view showing part of a handpiece 1. The handpiece 1 forms part of a housing of a drive for rotating a blade, which shall be described hereinafter. The handpiece 1 is held by the surgeon during use of a surgical instrument.

The handpiece 1 comprises a centric, substantially cylindrical recess 3 into which an end portion or coupling portion of a surgical instrument 2 can be slid. Sealing relative to the housing of the handpiece 1 is performed by way of an O-ring 10.

For axially securing the surgical instrument 2, the instrument comprises a latch element 6 with a snap-in element 5 which can be snapped into a circular annular locking recess 4 formed on the wall of the recess 3.

FIG. 1 shows a covering cap 12 which is attached to the end portion of the surgical instrument 2 and comprises a recess by which a pushbutton 8 is held and positioned, the pushbutton 8 being connected to a pressure plate 9 which abuts on a plate-shaped latch element 6. When pressure is exerted on the pushbutton 8 in radial direction, the latch element 6 is shifted against the force of an elastic element 7 (leaf spring) so that the snap-in element 5 is detached from the locking recess 4 and can be brought into a release position.

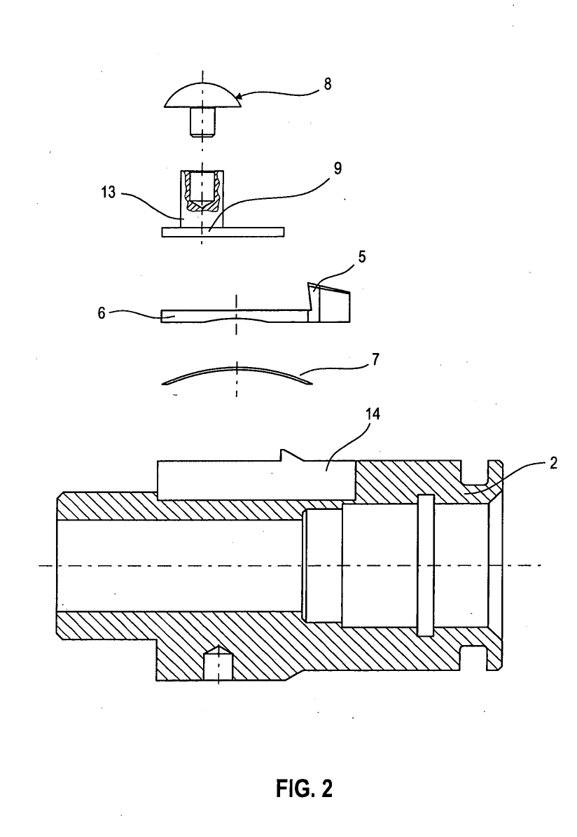

The structure of the individual elements can be seen in the exploded view of FIG. 2.

The snap-in element 5 is wedge-shaped or beveled, so that when the surgical instrument 2 is slid into the handpiece 1, the element is pressed by the inner wall of the recess 3 radially inwards against the force of the leaf spring to effect an automatic locking operation.

As can particularly be seen in FIG. 2, the pressure plate 9 has connected thereto a substantially cylindrical shoulder 13 which comprises an internal thread into which a thread of the pushbutton 8 can be screwed. The pushbutton 8 can thereby be mounted.

As shown in FIG. 1, the covering cap secures both the latch element 6 guided in a groove 14 and the leaf spring 7 which radially abuts inside the latch element 5 against the element and against the base of groove 14. Furthermore, the covering cap 12 secures the pressure plate 9 and keeps it in its position.

The provision of the leaf spring 7 with suitable dimensions and a suitable shape has the effect that pressure exerted on the pushbutton 8 will shift the latch element 6 substantially in radial direction, but will not clamp or pivot the same, so as to move the snap-in element 5 out of the inoperative position as shown in FIG. 1 into a release position.

FIG. 1 further shows part of a drive 15 for a blade 16 (shaver blade). Both drive 15 and blade 16 are already known from the prior art, so that reference can be made to the prior art (see e.g. DE 696 31 340 T2). Drive 15 (drive shaft) is sealed relative to the surgical instrument 2 (housing of the shaver blade) via O-rings 17. The coupling of the drive 15 with the blade 16 and the corresponding other designs are already known from the prior art (see above) so that a detailed description is here not needed. This is equally true for a positioning pin 11, which forms an anti-rotation mechanism.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A surgical coupling device for releasably connecting a handpiece to a surgical instrument comprising:
a handpiece having a recess into which a coupling portion of the surgical instrument can be detachably slid;
a locking recess formed on an interior wall of the recess;
a snap-in element adapted to be brought into detachable engagement with the locking recess, said snap-in element being supported on the surgical instrument;
a latch element having said snap-in element and extending substantially in an axial direction and which is radially shiftably supported on the surgical instrument;
at least one elastic element to bias said latch element radially outwards into an inoperative position; and
an actuating element to move said latch element against the bias of said elastic element into a release position.

2. A surgical coupling device as set forth in claim 1 wherein said latch element is substantially plate-shaped.

3. A surgical coupling device as set forth in claim 1 wherein said latch element is arranged in a groove of the surgical instrument.

4. A surgical coupling device as set forth in claim 1 wherein said actuating element comprises a manually operable pushbutton.

5. A surgical coupling device as set forth in claim 4 wherein said manually operable pushbutton is connected to a pressure plate which abuts radially outside against said latch element.

6. A surgical coupling device as set forth in claim 1 wherein said elastic element is designed in the form of a leaf spring.

7. A surgical coupling device as set forth in claim 1 wherein said latch element, said elastic element, and said pressure plate are secured by a covering cap radially outwards in the groove.
